(19) United States
(12) Patent Application Publication
(10) Pub. No.: US 2022/0335500 A1
(43) Pub. Date: Oct. 20, 2022

(54) EMBEDDABLE RECOMMENDATION SYSTEM FOR CANNABIS STRAINS AND PRODUCTS

(71) Applicant: StrainBrain Technologies Inc., Hamilton (CA)

(72) Inventors: Andrew Leber, Hamilton (CA); Graham Bohm, Hamilton (CA)

(21) Appl. No.: 17/722,755

(22) Filed: Apr. 18, 2022

Related U.S. Application Data
(60) Provisional application No. 63/175,764, filed on Apr. 16, 2021.

(51) Int. Cl. G06Q 30/06

(52) U.S. Cl. CPC G06Q 30/0631

(57) ABSTRACT

An embeddable system and methods for recommending cannabis strains/products is provided. The system implements a matching algorithm to identify cannabis strains/products in a centralized database that match with selection criteria entered by a customer. The system further generates an embeddable recommendation interface that presents the matching strains/products within the confines of a retailer website, retailer kiosk or manager device. The input selection criteria and the matched strains/products output by the matching algorithm may be stored as analytics. The system acts independently of any underlying retail inventory management or point of sale services but may access and present inventory and point of sale information for matching strains/products within the recommendation interface. The system further receives retailer branding information such as colors, fonts, and designs to customize the recommendation interface to suit retailer branding and desired customer experience.

### TECHNICAL FIELD

The embodiments disclosed herein relate to systems and methods for automatically recommending a product based on user input criteria, and, in particular to an embeddable recommendation system for cannabis strains/products.

### INTRODUCTION

There are thousands of different strains of cannabis. Each strain has a unique cannabinoid and terpene chemical profile, which contributes to its distinct set of recreational, medicinal, and adverse effects, as well its psychoactive strength. These strains form the basis of many cannabis products, which may sell the dried flower of a cannabis strain or a derivative of the same, such as extracted oils. This large selection of subtly differentiated products can be overwhelming for consumers to choose from, particularly new or inexperienced users.

Many cannabis strains and products only indicate the relative amount of cannabinoid (i.e., tetrahydrocannabinol (THC) or cannabidiol (CBD)), without describing the terpene chemical profile or medicinal/recreational effects. Furthermore, there is no standardization of strain names or nomenclature to describe the particular chemical profile and effects of a given strain. Thus, users must sample strains in trial-and-error fashion to identify a strain that has the effects desired by the user. A further complication is that the same strain may be called by different names by different producers/retailers.

Cannabis product recommendation systems are an attractive prospect, being able to drastically improve the consumer experience by matching users with the products that most fulfills their needs. This is especially true when the system can act in places where humans cannot easily assist in product selection, such as on a cannabis retailer website. This is also especially true for unknowledgeable cannabis users who have little basis for their product choice. There are millions of new cannabis users falling into this category every year, likely a product of many jurisdictions passing laws that are permissive of medicinal and/or recreational cannabis use.

Accordingly, there is a need for an automated system for recommending cannabis strains from a centralized dataset of cannabis products based on user criteria. Furthermore, it is desirable for a recommendation system that is embeddable in existing cannabis retailer websites or kiosks for recommending products that are stocked by the retailer.

### SUMMARY

According to an aspect, there is a system for recommending cannabis strains/products. The system comprises a server configured to: receive selection criteria from a retailer website or a kiosk as entered by a customer; match the selection criteria to one or more cannabis strains among a plurality of strains in a centralized database by comparing the selection criteria to retailer data for the one or more strains; and generate an embeddable recommendation interface for presenting the one or more strains via the website or the kiosk, wherein the embeddable recommendation interface is independent of inventory management or point of sale services of the website and the kiosk.

The system may be further configured to receive retailer data about the plurality of cannabis strains from the website or the kiosk and store the retailer data in the centralized database. The system may be further configured to store analytics data in an analytics database, wherein the analytics data includes the selection criteria and the retailer data for the one or more strains.

According to some embodiments, the embeddable recommendation interface is generated as an HTML iframe embeddable within the website. According to other embodiments, the embeddable recommendation interface is hosted by a third-party system and embedded onto the website.

Another aspect provides a method for an embeddable recommendation. The method comprises: receiving, at a server, selection criteria from a website or a kiosk as entered by a customer; matching the selection criteria to one or more cannabis strains among a plurality of strains in a centralized database by comparing the selection criteria to retailer data for the one or more strains; and generating an embeddable recommendation interface presenting the one or more strains via the website or the kiosk.

Other aspects and features will become apparent, to those ordinarily skilled in the art, upon review of the following description of some exemplary embodiments.

### BRIEF DESCRIPTION OF THE DRAWINGS

The drawings included herewith are for illustrating various examples of articles, methods, and apparatuses of the present specification. In the drawings:

FIG. 1 is a diagram of an embeddable recommendation system, according to an embodiment;

FIG. 2 is a flow chart of a method for an embeddable recommendation, according to an embodiment; and

FIG. 3 is a flow chart of a method for an embeddable recommendation, according to another embodiment.

### DETAILED DESCRIPTION

Various apparatuses or processes will be described below to provide an example of each claimed embodiment. No embodiment described below limits any claimed embodiment and any claimed embodiment may cover processes or apparatuses that differ from those described below. The claimed embodiments are not limited to apparatuses or processes having all of the features of any one apparatus or process described below or to features common to multiple or all of the apparatuses described below.

One or more systems described herein may be implemented in computer programs executing on programmable computers, each comprising at least one processor, a data storage system (including volatile and non-volatile memory and/or storage elements), at least one input device, and at least one output device. For example, and without limitation, the programmable computer may be a programmable logic unit, a mainframe computer, server, and personal computer, cloud-based program or system, laptop, personal data assistance, cellular telephone, smartphone, or tablet device.

Each program is preferably implemented in a high-level procedural or object-oriented programming and/or scripting language to communicate with a computer system. However, the programs can be implemented in assembly or machine language, if desired. In any case, the language may be a compiled or interpreted language. Each such computer program is preferably stored on a storage media or a device readable by a general or special purpose programmable computer for configuring and operating the computer when the storage media or device is read by the computer to perform the procedures described herein.

A description of an embodiment with several components in communication with each other does not imply that all such components are required. On the contrary a variety of optional components are described to illustrate the wide variety of possible embodiments of the present invention.

Further, although process steps, method steps, algorithms or the like may be described (in the disclosure and/or in the claims) in a sequential order, such processes, methods and algorithms may be configured to work in alternate orders. In other words, any sequence or order of steps that may be described does not necessarily indicate a requirement that the steps be performed in that order. The steps of processes described herein may be performed in any order that is practical. Further, some steps may be performed simultaneously.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article.

The following describes a system and methods to provide automatic cannabis strain/product recommendations to consumers. The system maintains an independent and centralized database of cannabis strains/products, along with their characteristics required for recommendations. Using this database, the retailer's current inventory can be cross-referenced and the stain(s)/product(s) that matches the customer input can be recommended through the use of a recommendation interface embedded onto the retailer website or in-store kiosk.

The system acts independently of any underlying inventory management or point of sale services of the retailer, and forms a “layer” on top of such services, providing for wide applicability/compatibility with various retailer inventory management and point of sale services/systems. The system differs from existing point of sale software that has a recommendation engine that is part of the point of sale software itself and is not portable to work with other point of sale services, systems, etc.

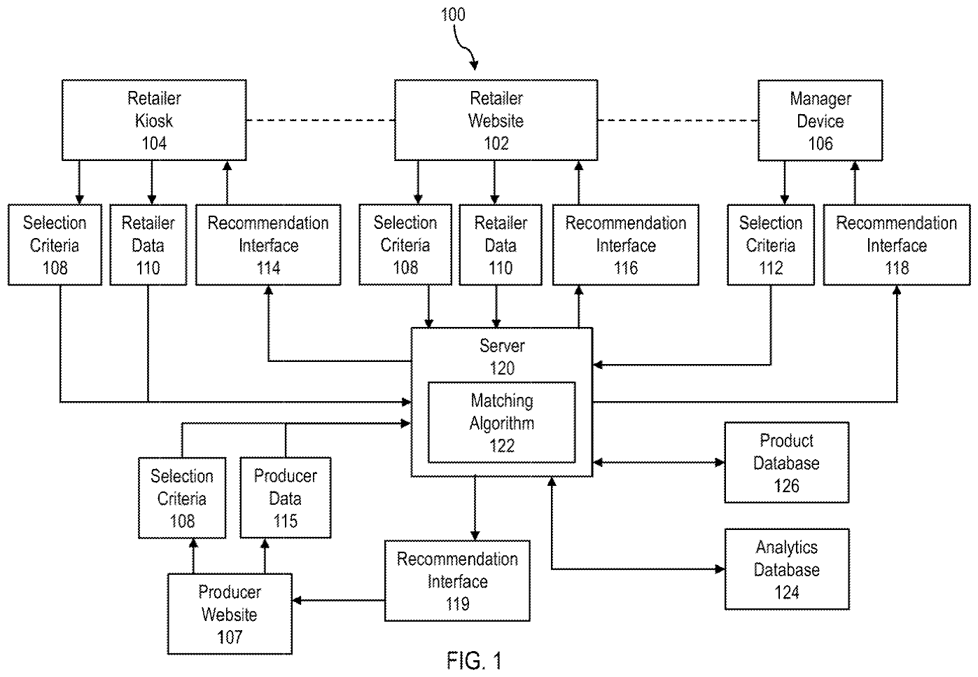

Referring to FIG. 1, illustrated therein is a diagram of a system 100 for recommending cannabis strains/products, according to an embodiment.

The system 100 includes a cannabis retailer website 102. The retailer website 102 may be operated by a cannabis retailer for customers to order or purchase cannabis strains/products through the retailer website 102. The retailer website 102 may include a customer-facing frontend site and an employee-facing backend site for access to the website 102 by customers and employees, respectively. Generally, information related to the retailer and the cannabis strains/products sold by the retailer are created and entered by employees on the backend site and will be presented to customers on the frontend site.

The system 100 includes a retailer kiosk 104. The retailer kiosk 104 is typically located at a cannabis retailer brick and mortar store. The retailer kiosk 104 may be, for example, a tablet or interactive device having a display and a user interface for receiving user input. The retailer kiosk 104 may have an internet connection and may be used to access the retailer website 102. The retailer kiosk 104 may be installed with an application for accessing the retailer website 102 backend.

The system 100 includes a manager device 106. The manager device 106 may be a laptop, tablet, or the like, having a display and a user interface for receiving manager input. The manager device 106 may have an internet connection and may be used to access the retailer website 102. The manager device may be installed with an application for accessing the retailer website 102 backend.

The system includes a cannabis producer website 107. The producer website 107 may be operated by a cannabis producer that cultivates cannabis strains and produces cannabis products but does not generally sell directly to customers. The producer website 107 may include a user-facing frontend site and an employee-facing backend site for access to the producer website 107 by users and employees, respectively.

In FIG. 1, one retailer website 102, one retailer kiosk 104, one producer website 107 and one manager device 106 are shown for ease of illustration. According to other embodiments, the system 100 may include a plurality of retailer websites, retailer kiosks, producer websites and manager devices in connection with a server 120. The plurality of websites, kiosks and devices may be operated by a plurality of cannabis retailers and producers.

Each retailer website 102, retailer kiosk 104, producer website 107 and manager device 106 is registered with the system 100 to connect to the server 120 via WebSocket APIs, or other secure communication protocols, to exchange data with the server 120.

The server 120 includes a computer processor operably coupled to a memory. The memory stores a plurality of instructions that are executable by the processor. In this respect, the term “executable” means a program file that is in a form that can ultimately be run by the processor. Examples of executable programs may be, for example, a compiled program that can be translated into machine code in a format that can be loaded into a random access portion of the memory and run by the processor; source code that may be expressed in proper format such as object code that is capable of being loaded into a random access portion of the memory and executed by the processor; source code that may be interpreted by another executable program to generate instructions in a random access portion of the memory to be executed by the processor; algorithms, etc.

The server 120 is configured to receive inputs of retailer data 110, producer data 115 and selection criteria 108, 112 and output recommendations for cannabis strains/products based on a comparison of the selection criteria 108, 112 and the producer data 115 and/or the retailer data 110. The output recommendations may be stored in an analytics database 124 with the associated selection criteria 108.

The server 120 is configured to vectorize the selection criteria 108, 112, wherein each selection criterion forms an axis, a scale (e.g., 1-100), or a component of a vector representing the (overall) selection criteria 108, 112, in model space. Similarly, the server 120 is configured to vectorize cannabis strains/products received in the retailer data 110 and producer data 115 wherein strain/product information such as size/weight, cannabinoid profile, terpene chemical profile, medicinal effects, recreational effects, taste, scent, pricing, retailer location, etc., are components of a vector representing the strain/product. The vectorized selection criteria 108, 112 and the vectorized strain/product information may stored in a database or memory of the server 120.

The server 120 is configured to implement a matching algorithm 122. The matching algorithm may be configured to determine a cosine similarity between the section criteria 108, 112 (represented as a vector) and every cannabis strains/product received in the retailer data 110 and producer data 115 (also represented as a vector). The matching algorithm 122 may be further configured to determine a match percentage, that is, a partially normalized cosine similarity score, for ranking the degree to which a given cannabis product/strain vector matches the selection criteria 108, 112 vector.

The server 120 is further configured to generate recommendation interfaces 114, 116, 118, 119 for presenting the recommended strains/products via the retailer kiosk 104, retailer website 102, the producer website 107 and the manager device 106, respectively. Each recommendation interface 114, 116, 118, 119 operates within the confines of the retailer kiosk 104, the retailer website 102, the manager device 106, and the producer website 107, respectively, independent of any underlying inventory management or point of sale services running on the retailer website 102, the retailer kiosk 104, the manager device 106 and the producer website 107.

Accordingly, the recommendation interfaces 114, 116, 118, 119 are “embeddable” within each of the retailer website 102, retailer kiosk 104, manager device 106 and producer website 107, to work in concert with underlying inventory management and point of sale services. For example, the recommendation interface 114, 116 may display the recommended strains/products, the inventory levels and pricing for the recommended strains/products, and provide a link to order or purchase the recommended strains/products through point-of-sale services of the retailer website 102 or the retailer kiosk 104.

Instructions for generating and embedding the recommendation interface 116, may be provided to the server 120 when the retailer website 102 is registered with the system 100, and may be updated thereafter when retailer data 110 is received. For example, the retailer data 110 received from the retailer website 102 may include branding information including fonts, colors and graphics for generating the recommendation interface 116. Similarly, code/instructions for embedding the recommendation interface 116 into the retailer website 102 may be included in the retailer data 110.

According to various embodiments, the server 120 may be configured to recognize an input source (e.g., the retailer website 102) that sends the selection criteria 108, and generate the recommendation interface 116, based on the input source of the selection criteria 108. For example, the server 120 may be configured to identify that the selection criteria 108 is received from the retailer website 102 and generate a suitable recommendation interface 116 for embedding into the retailer website 102 according to branding information and embedding instructions in the retailer data 110.

The recommendation interface 116 may be embedded into the retailer website 102, by means of either internal hosting or external hosting through, for example, HTML iframes, or similar techniques. The flexibility in hosting the recommendation interface 116 internally (i.e., on the server 120) or externally (i.e., on the retailer website 102) allows for wider applicability and implementation of the system 100, according to retailer preference and/or the retailer website 102 architecture.

According to some embodiments, the recommendation interface 116 may be embedded by distributing the entire code for the recommendation interface 116 to be hosted internally on the retailer website 102, or private/in-house cloud storage, and connected to the server 120 by APIs, or other known techniques. In such an embodiment, the logic for the generation, embedding and display of the recommendation interface 116 is included within the retailer website 102 content, but the information presented within the recommendation interface 116 is retrieved from the server 120 by API calls.

According to other embodiments, the recommendation interface 116 may be hosted external to the retailer website 102, for example, hosted by the server 120, and be embedded as a view and interactivity “window” on the retailer website 102. User interaction with, and the exchange of information between the retailer website 102 displaying the recommendation interface window and the server 120 hosting the recommendation interface 116 may be made by API calls, or other known communication protocols instituted between the server 120 and a server hosting the retailer website 120.

The recommendation interfaces 114, 118, 119, may be embedded on the retailer kiosk 104, the manager device 106 and the producer website 107, respectively, in substantially the same manner as described for the recommendation interface 116.

Following display of the recommendation interface 114, 116, 119 in either the kiosk 104 or the websites 102, 107 there may be the option the customer to place an order for a selected strain/product in the recommendation interface 114, 116, 119 using a third-party fulfillment/point-of sale software for their order to be filled using smart locker technology for a contact-less experience.

According to some embodiments, the recommendation interface 114, 116 may also include “up-selling”, or recommendation of other products that may be synergistic with the recommended strains/products. For example, if user selection criteria resulted in a dried flower product being recommended, the recommendation interface 114, 116 may additionally include a recommendation for rolling paper to consume the flower. According to other embodiments, the recommendation interface 114, 116 may further contain advertisements for products that are unrelated to the recommended strains/products.

In the case of recommendation interface 119, the interface 119 may display one or more recommended strains/product produced by the producer and display a link to a retailer website 102 to purchase the recommended strain/product and/or display the location of nearby retailers stocking the recommended strain/product.

Retailer data 110 and selection criteria 108 from the retailer website 102, retailer kiosk 103, selection criteria 108 and producer data 115 from the producer website 107, and selection criteria 112 from the manager device 106 are received and processed by the server 120.

Retailer data 110 includes current available product inventory; future product inventory; location; strain/product information such as a name, description, size/weight, cannabinoid profile, terpene chemical profile, medicinal effects, recreational effects, taste, scent, pricing, etc.; a preferred list of products to recommend; criteria on which products should be recommended; branding information such as colors, fonts, and designs of the retailer to customize the recommendation interface; information about the retailer such as retail location and sales volume. Retailers can mark certain strains/products to preferentially recommend based on high profit margin, a need to clear stock levels, or other retailer-specific criteria.

Retailer data 110 is typically acquired automatically from a retailer point-of-sale inventory database/software (not shown). For example, the retailer data 110 may be acquired by the server 120 when the retailer website 102 is registered with the system 100, or the server 120 may be configured to connect to a retailer point-of-sale inventory database/software by APIs or other known techniques to obtain the retailer data 110.

According to some embodiments, the retailer data 110 may be entered by an employee via the retailer website 102 or the retailer kiosk 104. According to other embodiments (not shown), the retailer data 110 may be entered via the manager device 106. The retailer data 110 is received and stored by the server 120 in a centralized product database 126. The retailer data 110 may be updated, when required, so that the retailer need not resend branding information for each new product/recommendation. Further, the inventory information in the retailer data 110 is applied to the centralized product database 126, to compare the available retail stock levels against the centralized database 126 to form a location-specific recommendation and prevent situations where strains/products that are not in stock at a particular retailer are recommended.

Producer data 115, includes substantially the same information as retailer data 110, but specific to the producer. For example, producer data 115 may include strain/product information such as a name, description, size/weight, cannabinoid profile, terpene chemical profile, medicinal effects, recreational effects, taste, scent, suggested pricing, etc. The producer data 115 is received and stored by the server 120 in the centralized product database 126.

The centralized product database 126 may group various cannabis strains/products according to standardized strain names or nomenclature that describe the particular chemical profile, the effects and the lineage of a given strain. Assigning a standardized strain name/nomenclature to the different retailer/producer names for a given strain/product may be performed by an administrator of the system 100. According to an embodiment, the centralized product database 126 may include a reference table for cross referencing the standardized strain name/nomenclature with the various different retailer/producer names for the given strain.

The server 120 may be configured to automatically assign a standardized strain name/nomenclature to the different strain/product names based on the chemical profile, effects, lineage, etc. for the strain/product as included in the retailer data 110 and/or the producer data 115. The server 120 may be further configured to accrue and store strain/product information, including the chemical profile, the effects and the lineage of a particular strain from a variety of third-party sources, including cannabis research organizations, regulatory bodies and cannabis review websites.

Selection criteria 108 is used by the matching algorithm 122 to recommend cannabis strains/products that match the selection criteria 108. The selection criteria 108 is entered by a customer via the retailer website 102, the retailer kiosk 104 or the producer website 107. The selection criteria 108 may be input via a selection interface provided on the websites 102, 107 and the kiosk 104.

The selection criteria 108 includes a customer's desired qualities/criteria for the strains/products they are seeking. The selection criteria 108 includes, but is not limited to, one or more of: medicinal effects, recreational effects, psychoactive strength/concentration, cannabinoid profile, terpene profile, taste, scent, price, format, preparation technique (e.g., organic), etc. The selection criteria 108 may further include personal information relating to the customer (age, gender, address or GPS location, medical conditions, cannabis consumption frequency, preferred format, etc.).

The selection criteria 108 may be stored in an analytics database 124 so that customer information/demographics and selection criteria can be saved for market analytics, performed either by the retailer, the producer or the party providing the recommendation system 100.

The selection criteria 112 is entered by a manager via the manager device 106. The selection criteria 112 includes products to stock, which could be based on criteria the manager perceives to have high customer demand. For example, the selection criteria 112 may be used to query the analytics database 124 for the most highly recommended strains/products for a particular (customer) selection criteria 108.

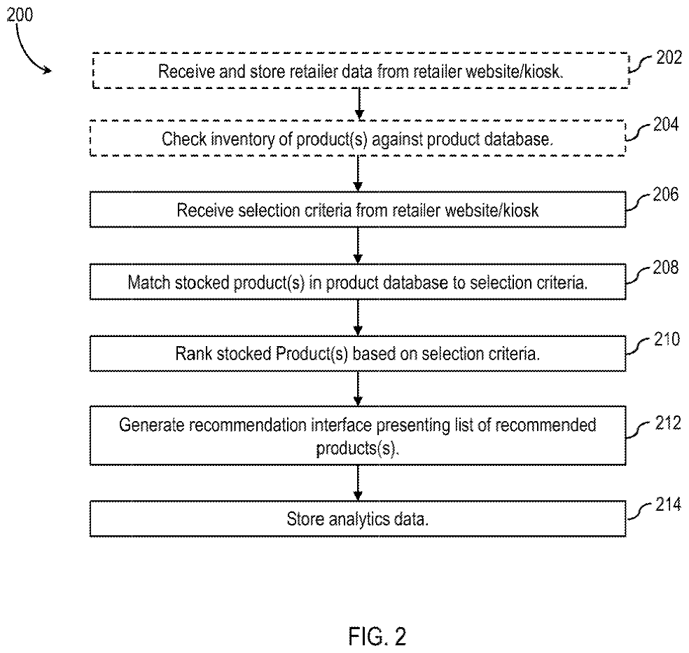

Referring to FIG. 2, illustrated therein is a flow chart of a method 200 for an embeddable recommendation, according to an embodiment. The method 200 addresses the problem of an inexperienced customer choosing between many subtly differentiated cannabis strains/products. The method 200 further provides an automated method to assist customers, thus lowering staffing requirements, and freeing up employees to perform other tasks. The method 200 may be performed by the server 120 and components of the system 100 in FIG. 1. For reference, the elements from FIG. 1 are identified in parenthesis.

At 202, retailer data (110) from a retailer website (102) or a retailer kiosk (104) is received at a server (120). The retailer data (110) is stored in a centralized product database (126). The retailer data (110) may be processed by the server (120) to vectorize cannabis strain/product information that is included in the retailer data (110) and store the vectorized strain/product data in a database or memory of the server (120).

At 204, the inventory levels in the retailer data (110) is checked against the inventory levels stored in the product database (126) and the stored inventory levels are updated, if necessary. This step is performed to ensure accuracy of inventory levels and ensure that only strains/products that are in stock are subsequently recommended later in the method 200.

According to some embodiments, the acts 202 and 204 may be performed simultaneously. The acts 202 and 204 may not be performed during every implementation of method 200, where for example, retailer data (108) is stored in advance and inventory checking is performed in real time.

At 206, selection criteria (108) from the retailer website (102) or the retailer kiosk (104) is received at the server (120). The selection criteria (108) may be vectorized by the server (120) to generate a vector representing the selection criteria (108) in model space.

At 208, the matching algorithm (122) matches cannabis strains/products in the product database (126) to the section criteria (108). The matching algorithm (122) may determine a cosine similarity between the vectorized section criteria (108) and vectorized cannabis strains/product in the product database (126). As noted above, only strains/products that are in stock at the retailer (according to the retailer data received at 202 and inventory check at 204 are vectorized and considered by the matching algorithm (122). This may provide for less memory usage and faster matching by the matching algorithm (122) in near real time.

At 210, the matching strains/products that are in stock are ranked according to the selection criteria (108). The ranking may involve assigning a match percentage, a score or a coefficient to each vectorized strain/product based on how well the strain/product fits the vectorized selection criteria (108). For example, the match percentage may be a partially normalized cosine similarity score, for ranking the degree to which a given cannabis product/strain vector matches the selection criteria (108) vector. Each selection criterion may be weighted (either a preset weight or as determined by the matching algorithm 122 based on the selection criteria 108) to calculate the match percentage, the score or the coefficient for how well a given strain/product fits the selection criteria (108).

At 212, the server (120) generates a recommendation interface (114, 116) to display a list of the recommended strains/products via the retailer website (102) or the retailer kiosk (104). The list of recommended strains/products is generally a subset of the ranked products determined at act 210. For example, the list of recommended strains/products may include the top five strains/products, as determined by the matching algorithm (122) based on the ranking at Act 210 (e.g., the five products with the highest match percentage) or may include the strains/products with a match percentage above a threshold value. According to other embodiments, the list of recommended strains/products may include all of the matching stains/products ranked from highest to lowest score.

The recommendation interface (114, 116) may include the retailer data (110) associated with the matching strain/products, for example, a product name, cannabinoid profile, terpene profile, price, retailer location, etc. The recommendation interface (114, 116) may include the match percentage or score of each matching strain/product. As noted above, the recommendation interface (114, 116) is embedded within the retailer website (102) or the retailer kiosk (104) and may include links to the retailer's inventory and point-of-sale services so that the customer may order or purchase the matching strains/products from the retailer by clicking the link(s) in the recommendation interface (114, 116).

The server (120) is further configured to generate the recommendation interface (114, 116) to include design and branding information (i.e., colors, fonts, and designs included in the retailer data 110) and generate the visual representation of the recommendation interface (114, 116) to suit retailer branding and desired customer experience.

At 214, analytics are stored in the analytics database (124). The analytics include the selection criteria (108) received by the server (120) and the matching strains/products matched to the selection criteria (108) as determined by the matching algorithm (122). The analytics may also include sales volumes and transaction details for the matching strains/products that are actually ordered or purchased via the links presented in the recommendation interface (114, 116).

The method 200, may also be used in the context of training employees how to make product recommendations, or used to guide product recommendations in real-time. This solves the problems of high staff costs by having some customers served by the retailer kiosk 104 or the retailer website 102, rather than by an employee. Further, the method 200 may prevent inexperienced employees from giving inaccurate recommendations and assist them in near real-time to quickly recommend a product/strain matching the customer's selection criteria 108.

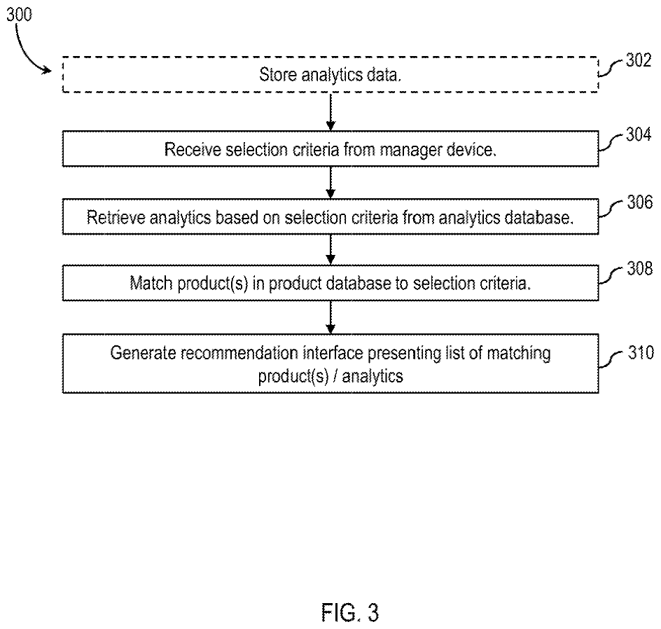

Referring to FIG. 3, illustrated therein is a flow chart of a method 300 for an embeddable recommendation, according to an embodiment. The method 300 may be performed to guide procurement decision by retail managers as to which products to stock based on qualities of desired products, customer selection criteria, and recommendation analytics. The method 300 may be performed by the server 120 and components of the system 100 in FIG. 1. For reference, the elements from FIG. 1 are identified in parenthesis.

At 302, analytics are stored in the analytics database (124). The analytics include the selection criteria (108) received by the server (120) and the matching strains/products matched to the selection criteria (108) as determined by the matching algorithm (122). The analytics may also include sales and transaction details for the matching strains/products that are actually ordered or purchased via the links presented in the recommendation interface (114, 116).

The act 302, may not be performed during every implementation of method 300, where, for example, analytics data is stored in advance. The act 302 may be the same as the act 214 in method 200, whereby method 300 may be performed following method 200.

At 304, selection criteria (112) is received from a manager device (106) and differs from the selection criteria (108) entered by a customer. The selection criteria (112) may be criteria for determining prospective products to stock, which could be based on strains/products the retail manager perceives to have high customer demand or desirability based on the analytics stored in the analytics database (124). For example, the section criteria (112) may be used by the server (120) to query the analytics database (124) for the most recommended strains/products for a particular (customer) selection criterion (108).

At 306, analytics are retrieved from the analytics database (124) based on the selection criteria (112). The retrieved analytics may be, for example: the most commonly entered customer selection criteria; the most recommended stains/products for a given medicinal effect; the most recommended stains/products for a given recreational effect, the match percentage of how well the customer selection criteria matches the retailer data for a given strain, etc.

At 308, the matching algorithm, identifies the strains/products in the centralized product database (126) matching the selection criteria (112) and/or the analytics retrieved at Act 306.

At 310, the server (120) generates a recommendation interface (118) to present a list of the matching strains/products/analytics via the manager device (106). In this way, the retail manager may use the system 100 to make procurement decisions based on the analytics stored in the analytics database (124).

While the above description provides examples of one or more apparatus, methods, or systems, it will be appreciated that other apparatus, methods, or systems may be within the scope of the claims as interpreted by one of skill in the art.

1. An embeddable system for recommending cannabis strains and products, comprising:
a processor; and
a memory operably coupled to the processor, and having stored thereon processor-executable instructions that, when executed, cause the system to:
receive and store branding information and embedding instructions from an input source, wherein the input source is a website, a kiosk or a device;
receive and store selection criteria from the input source, as entered by a user;
match the selection criteria to one or more cannabis strains among a plurality of strains in a centralized database, by comparing the selection criteria to retailer data for each strain;
generate an embeddable recommendation interface according to the branding information, for presenting the one or more strains to the user via the input source; and
embed the recommendation interface into the source according to the embedding instructions, wherein the recommendation interface is displayed via the input source independent of inventory management or point of sale services of the input source.

2. The system of claim 1, wherein the memory further comprises instructions to cause the processor to:
receive the retailer data for each strain, including a strain name, a chemical profile, one or more effects and a lineage, from the input source;
assign a standardized name for each strain based on the chemical profile, the one or more effects and the lineage; and
store the retailer data, the strain name and the standardized name for each strain in the centralized database, whereby the standardized name is cross referenced to the strain name and the retailer data for each strain.

3. The system of claim 1, wherein the memory further comprises instructions to cause to processor to:
receive the retailer data for each strain, including an available inventory for each strain, from the input source;
store the available inventory for each strain in the centralized database; and
match the selection criteria to the one or more cannabis strains among the plurality of strains in the centralized database by comparing the selection criteria to the retailer data for each strain having the available inventory greater than zero.

4. The system of claim 1, wherein the recommendation interface displays one or more of:
a list of the one or more cannabis strains;
a list of retailers stocking the one or more cannabis strains;
a list of products related to the one or more cannabis strains; and
an option to purchase the one or more cannabis strains and the products by a third-party point of sale system.

5. The system of claim 1, wherein the memory further comprises instructions to cause the processor to:
store analytics data in an analytics database, wherein the analytics data includes:
the selection criteria;
the one or more strains matching the selection criteria; and
the retailer data for the one or more strains.

6. The system of claim 1, wherein the memory further comprises instructions to cause the processor to:
vectorize the selection criteria to form a selection vector in a model space;
vectorize the retailer data for each strain to form a strain vector for each strain in the model space;
store the selection vector and the strain vector for each strain in the memory;
determine a cosine similarity between the selection vector and each strain vector in the model space;
determine a match percentage for each strain vector, wherein the match percentage is a partially normalized cosine similarity ranking the degree to which each strain vector matches the selection vector;
rank each strain according to the match percentage to generate a list of the one or more strains.

7. The system of claim 1, wherein the retailer data for each strain further includes:
an available inventory; a future inventory; a sales volume; a retail location; a name, a description, a size/weight, a cannabinoid chemical profile, a terpene chemical profile, medicinal effects, recreational effects, a taste, a scent, pricing; and
recommendation criteria, including a profit margin and a stock level.

8. The system of claim 1, wherein the embeddable recommendation interface is generated as an HTML iframe embeddable within the input source.

9. The system of claim 1, wherein the embeddable recommendation interface is hosted by the input source and the one or more strains presented within the recommendation interface is updated by API calls.

10. A method for an embeddable recommendation, comprising:
receiving and storing, by a server, branding information and embedding instructions from an input source, wherein the input source is a website, a kiosk or a device;
receiving and storing, by the server, selection criteria from the input source as entered by a user;
matching, by the server, the selection criteria to one or more cannabis strains among a plurality of strains in a centralized database by comparing the selection criteria to retailer data for each strain; and
generating, by the server, an embeddable recommendation interface according to the branding information, for presenting the one or more strains via the input source.

11. The method of claim 10, further comprising:
embedding, by the server, the recommendation interface into the source according to the embedding instructions, wherein the recommendation interface is displayed via the input source independent of inventory management or point of sale services of the input source.

12. The method of claim 10, further comprising:
Storing, by the server, analytics data in an analytics database, wherein the analytics data includes:
the selection criteria;
the one or more strains matching the selection criteria; and
the retailer data for the one or more strains.

13. The method of claim 10, further comprising:
vectorizing, by the server, the selection criteria to form a selection vector in a model space;
vectorizing, by the server, the retailer data for each strain to form a strain vector for each strain in the model space;
storing, by the server, the selection vector and the strain vector for each strain in a memory;
determining, by the server, a cosine similarity between the selection vector and each strain vector in the model space;
determining, by the server, a match percentage for each strain vector, wherein the match percentage is a partially normalized cosine similarity ranking the degree to which each strain vector matches the selection vector;
ranking, by the server, each strain according to the match percentage to generate a list of the one or more strains.

14. The method of claim 10, wherein the embeddable recommendation interface is generated as an HTML iframe embeddable within the input source.

15. The method of claim 10, wherein the embeddable recommendation interface is hosted by the input source and the one or more strains presented within the recommendation interface is updated by API calls to the server.

16. A method for an embeddable recommendation, comprising:
receiving, at a server, manager selection criteria from a manager device, as entered by a manager;
matching, by the server, the manager selection criteria to one or more cannabis strains among a plurality of strains in an analytics database by comparing the manager selection criteria to analytics data for the one or more strains;
retrieving, by the server, the analytics data for the one or more strains from the analytics database; and
generating, by the server, an embeddable recommendation interface for presenting the analytics data for the one or more strains to the manager via the manager device.

17. The method of claim 16, further comprising:
storing the analytics data in the analytics database, wherein the analytics data includes:
customer selection criteria for the one or more strains; and
the retailer data for the one or more strains.

18. The method of claim 16, further comprising:
embedding, by the server, the recommendation interface as an HTML iframe within a website accessible via the manager device.

19. The method of claim 16, wherein the embeddable recommendation interface is hosted by a website accessible via the manager device.
